(19) United States
(12) Patent Application Publication
(10) Pub. No.: US 2013/0334900 A1
(43) Pub. Date: Dec. 19, 2013

(54) SLOTLESS ELECTRICAL MACHINES WITH MIXED FERROMAGNETIC/NON-FERROMAGNETIC CORE

(71) Applicant: Alexei Stadnik, Beverly Hills, CA (US)

(72) Inventor: Alexei Stadnik, Beverly Hills, CA (US)

(21) Appl. No.: 13/261,683

(22) PCT Filed: Dec. 22, 2011
(86) PCT No.: PCT/US11/66897

§ 371 Date: Jun. 27, 2013

Related U.S. Application Data
(60) Provisional application No. 61/460,241, filed on Dec. 28, 2010.

(51) Int. Cl. H02K 41/03; H02K 1/17

(52) U.S. Cl. CPC H02K 41/031; H02K 1/17
USPC 310/12.18; 310/216.002

(57) ABSTRACT

The invention provides slotless electrical machines with mixed ferromagnetic/non-ferromagnetic core (mixed core). The invented slotless electrical machines with mixed core have less attraction and cogging force than conventional electrical machines with ferromagnetic core.

### BACKGROUND OF THE INVENTION

The design of slotless electrical machine includes coils mounted on the core and permanent magnets. In the traditional construction, the core is made of ferromagnetic solid or laminated material (An Analytical Solution for the Normal Force in Linear Actuators by M. A. da Silveira, A. F. Flores Filho, R. P. Homrich—2005 IEEE International Conference on Electric Machines and Drives, May 2005). For this construction, the attraction and cogging force between permanent magnets and ferromagnetic core can be very high.

The invented construction of slotless electrical machines with mixed core provides less magnetic attraction and cogging force. The mixed core is made of both ferromagnetic and non-ferromagnetic laminations. In the construction with mixed core the attraction and cogging force is reduced.

### DESCRIPTION OF THE FIGURES

FIG. 1—Linear flat slotless electrical machine with forcer that includes ferromagnetic core.

FIG. 2—Invented linear flat slotless electrical machine with forcer that includes mixed core.

FIG. 3—Mixed ferromagnetic/non-ferromagnetic core for invented linear flat slotless electrical machine.

FIG. 4—Height mixed ferromagnetic/non-ferromagnetic core for invented linear flat slotless electrical machine.

FIG. 5—Invented linear flat slotless electrical machine with forcer that includes height mixed core.

FIG. 6—Random mixed ferromagnetic/non-ferromagnetic core for invented linear flat slotless electrical machine.

FIG. 7—Invented linear flat slotless electrical machine with forcer that includes random mixed core.

FIG. 8—Rotary slotless electrical machine with stator that includes ferromagnetic core.

FIG. 9—Invented rotary slotless electrical machine with stator that includes mixed core.

FIG. 10—Mixed ferromagnetic/non-ferromagnetic core for invented rotary slotless electrical machine.

FIG. 11—Radial mixed ferromagnetic/non-ferromagnetic core for invented rotary slotless electrical machine.

FIG. 12—Invented rotary slotless electrical machine with stator that includes radial mixed core.

FIG. 13—Random mixed ferromagnetic/non-ferromagnetic core for invented rotary slotless electrical machine.

FIG. 14—Invented rotary slotless electrical machine with stator that includes random mixed core.

FIG. 15—Linear tube slotless electrical machine (internal magnets) with forcer that includes ferromagnetic core.

FIG. 16—Invented linear tube slotless electrical machine (internal magnets) with forcer that includes mixed core.

FIG. 17—Mixed ferromagnetic/non-ferromagnetic core for invented linear tube slotless electrical machine (internal magnets).

FIG. 18—Radial mixed ferromagnetic/non-ferromagnetic core for invented linear tube slotless electrical machine (internal magnets).

FIG. 19—Invented linear tube slotless electrical machine (internal magnets) with forcer that includes radial mixed core.

FIG. 20—Random mixed ferromagnetic/non-ferromagnetic core for invented linear tube slotless electrical machine (internal magnets).

FIG. 21—Invented linear tube slotless electrical machine (internal magnets) with forcer that includes random mixed core.

FIG. 22—Linear tube slotless electrical machine (external magnets) with forcer that includes ferromagnetic core.

FIG. 23—Invented linear tube slotless electrical machine (external magnets) with forcer that includes mixed core.

FIG. 24—Mixed ferromagnetic/non-ferromagnetic core for invented linear tube slotless electrical machine (external magnets).

FIG. 25—Radial mixed ferromagnetic/non-ferromagnetic core for invented linear tube slotless electrical machine (external magnets).

FIG. 26—Invented linear tube slotless electrical machine (external magnets) with forcer that includes radial mixed core.

FIG. 27—Random mixed ferromagnetic/non-ferromagnetic core for invented linear tube slotless electrical machine (external magnets).

FIG. 28—Invented linear tube slotless electrical machine (external magnets) with forcer that includes random mixed core.

### DRAWINGS

### Reference Numerals

10—Forcer that includes coils and ferromagnetic solid or laminated core, linear flat slotless electrical machine.
12—Coils, linear flat slotless electrical machine.
14—Epoxy
16—Ferromagnetic solid or laminated core, linear flat slotless electrical machine.
18—Magnet track, linear flat slotless electrical machine.
20—Magnetic plate, linear flat slotless electrical machine.
22—Magnets, linear flat slotless electrical machine.
24—Forcer that includes coils and mixed core, linear flat slotless electrical machine.
26—Mixed core, linear flat slotless electrical machine.
28 and 36—Ferromagnetic (oriented or non-oriented) laminations, linear flat slotless electrical machine.
30 and 38—Non-ferromagnetic laminations, linear flat slotless electrical machine.
32—Height mixed core, linear flat slotless electrical machine.
34—Forcer that includes coils and height mixed core, linear flat slotless electrical machine.
40—Random mixed core, linear flat slotless electrical machine.
42—Forcer that includes coils and random mixed core, linear flat slotless electrical machine.
44—Stator that includes coils and ferromagnetic solid or laminated core, rotary slotless electrical machine.
46—Coils, rotary slotless electrical machine.
48—Ferromagnetic solid or laminated core, rotary slotless electrical machine.
50—Rotor, rotary slotless electrical machine.
52—Bushing, rotary slotless electrical machine.
54—Magnets, rotary slotless electrical machine.
56—Stator that includes coils and mixed core, rotary slotless electrical machine.
58—Mixed core, rotary slotless electrical machine.
60 and 64—Ferromagnetic (oriented or non-oriented) laminations, rotary slotless electrical machine.
62 and 66—Non-ferromagnetic laminations, rotary slotless electrical machine.
68—Radial mixed core, rotary slotless electrical machine.
70—Stator that includes coils and radial mixed core, rotary slotless electrical machine.
72—Random mixed core, rotary slotless electrical machine.
74—Stator that includes coils and random mixed core, rotary slotless electrical machine.
75—Forcer that includes coils and ferromagnetic solid or laminated core, linear tube slotless electrical machine (internal magnets).
76—Coils, linear tube slotless electrical machine (internal magnets).
78—Ferromagnetic solid or laminated core, linear tube slotless electrical machine (internal magnets).
80—Magnet track, linear tube slotless electrical machine (internal magnets).
82—Tube, linear tube slotless electrical machine (internal magnets).
84—Magnets, linear tube slotless electrical machine (internal magnets).
86—Forcer that includes coils and mixed core, linear tube slotless electrical machine (internal magnets).
88—Mixed core, linear tube slotless electrical machine (internal magnets).
90 and 94—Ferromagnetic (oriented or non-oriented) laminations, linear tube slotless electrical machine (internal magnets).
92 and 96—Non-ferromagnetic laminations, linear tube slotless electrical machine (internal magnets).
98—Radial mixed core, linear tube slotless electrical machine (internal magnets).
100—Forcer that includes coils and radial mixed core, linear tube slotless electrical machine (internal magnets).
102—Random mixed core, linear tube slotless electrical machine (internal magnets).
104—Forcer that includes coils and random mixed core, linear tube slotless electrical machine (internal magnets).
106—Forcer that includes coils and ferromagnetic solid or laminated core, linear tube slotless electrical machine (external magnets).
108—Coils, linear tube slotless electrical machine (external magnets).
110—Ferromagnetic solid or laminated core, linear tube slotless electrical machine (external magnets).
112—Magnet track, linear tube slotless electrical machine (external magnets).
114—Tube, linear tube slotless electrical machine (external magnets).
116—Magnets, linear tube slotless electrical machine (external magnets).
118—Forcer that includes coils and mixed core, linear tube slotless electrical machine (external magnets).
120—Mixed core, linear tube slotless electrical machine (external magnets).
122 and 126—Ferromagnetic (oriented or non-oriented) laminations, linear tube slotless electrical machine (external magnets).
124 and 128—Non-ferromagnetic laminations, linear tube slotless electrical machine (external magnets).
130—Radial mixed core, linear tube slotless electrical machine (external magnets).
132—Forcer that includes coils and radial mixed core, linear tube slotless electrical machine (external magnets).
134—Random mixed core, linear tube slotless electrical machine (external magnets).
136—Forcer that includes coils and random mixed core, linear tube slotless electrical machine (external magnets).

### DESCRIPTION OF THE PREFERRED EMBODIMENT

Linear Flat Slotless Electrical Machine with Mixed Core.

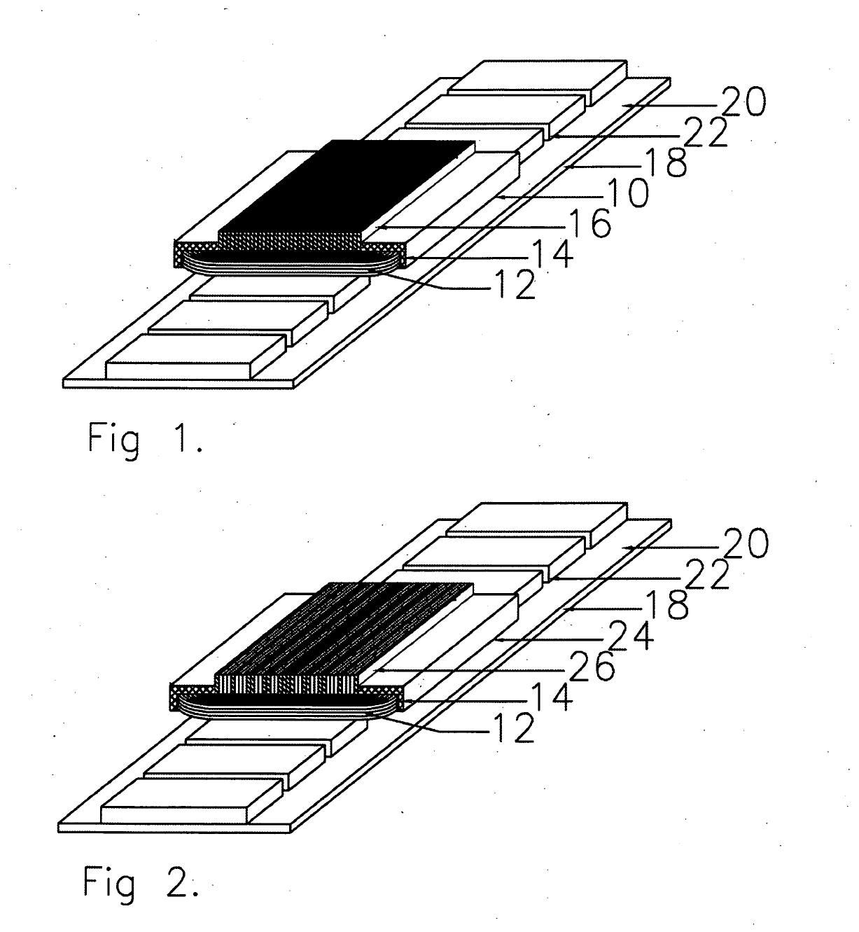

Linear flat slotless electrical machine with forcer that includes coils and ferromagnetic solid or laminated core for coils mounting is shown on FIG. 1. Forcer 10 consists of coils 12 encapsulated in epoxy 14 and ferromagnetic core 16. Magnet track 18 consists of magnetic plate 20 and magnets 22.

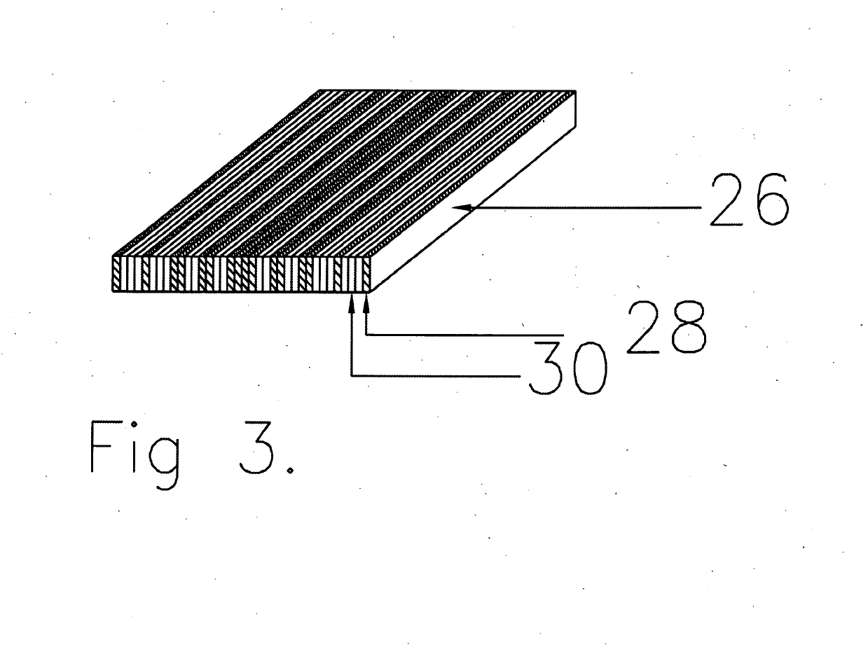

The invented linear flat slotless electrical machine construction includes forcer 24 consisted of coils 12 encapsulated in epoxy 14, and mixed ferromagnetic/non-ferromagnetic core 26 (FIG. 2). The mixed core replaces conventional ferromagnetic core 16. In the invented electrical machine the attraction and togging force is reduced.

The mixed core 26 for linear flat slotless electrical machine is shown on FIG. 3. It is made of ferromagnetic (oriented or non-oriented) laminations 28 and non-ferromagnetic laminations 30. Ferromagnetic and non-ferromagnetic laminations alternate along the core width.

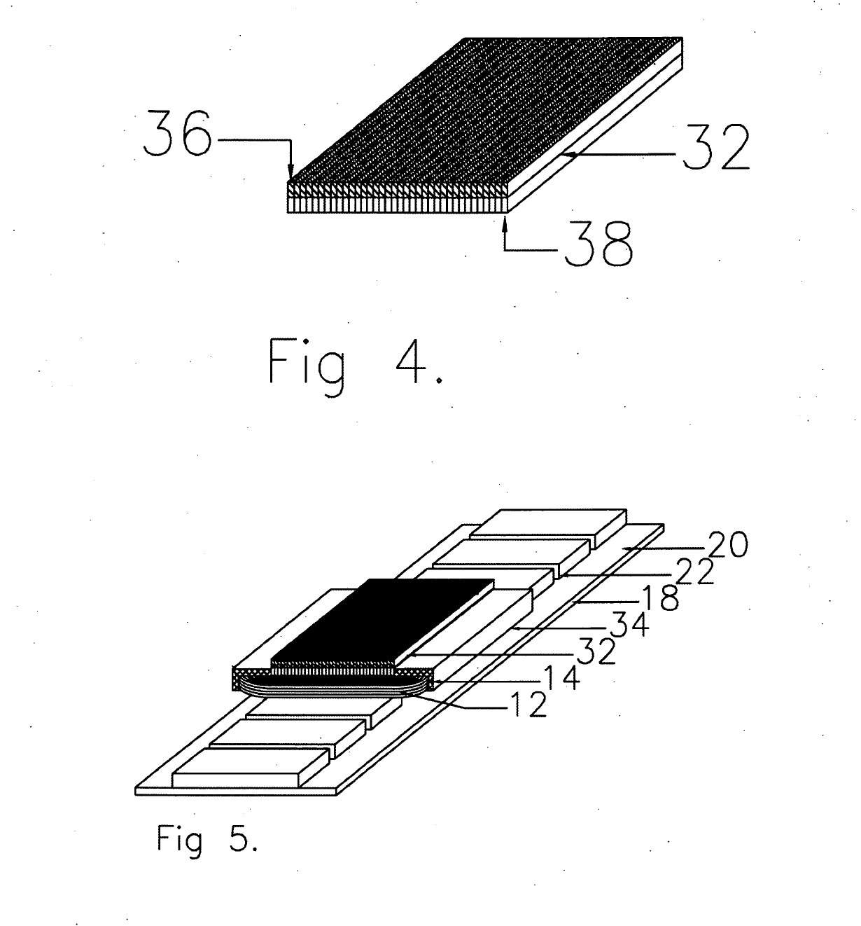

The mixed core can also be made of ferromagnetic laminations 36 and non-ferromagnetic laminations 38 that alternate along the core height. The construction of height mixed core 32 is shown on FIG. 4. The invented linear flat slotless electrical Machine construction that includes forcer 34 with height mixed core 32 is shown on FIG. 5.

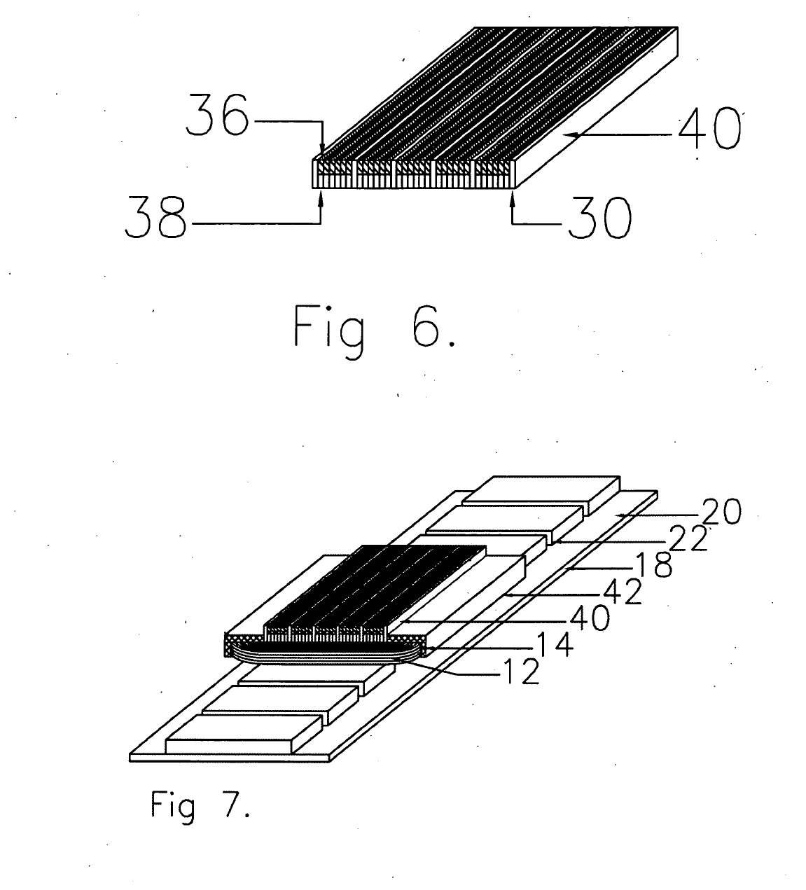

The mixed core can also be made of ferromagnetic laminations 36 and non-ferromagnetic laminations 30 and 38 that alternate both along the core height and along the core width. The construction of random mixed core 40 is shown on FIG. 6. The invented linear flat slotless electrical machine construction that includes forcer 42 with random mixed core 40 is shown on FIG. 7.

The exact dimensions, mutual position and quantity of ferromagnetic laminations 28 and 36 and non-ferromagnetic laminations 30 and 38 for any type of mixed core depend on electromechanical design and are subject for optimization.

Rotary Slotless Electrical Machine with Mixed Core.

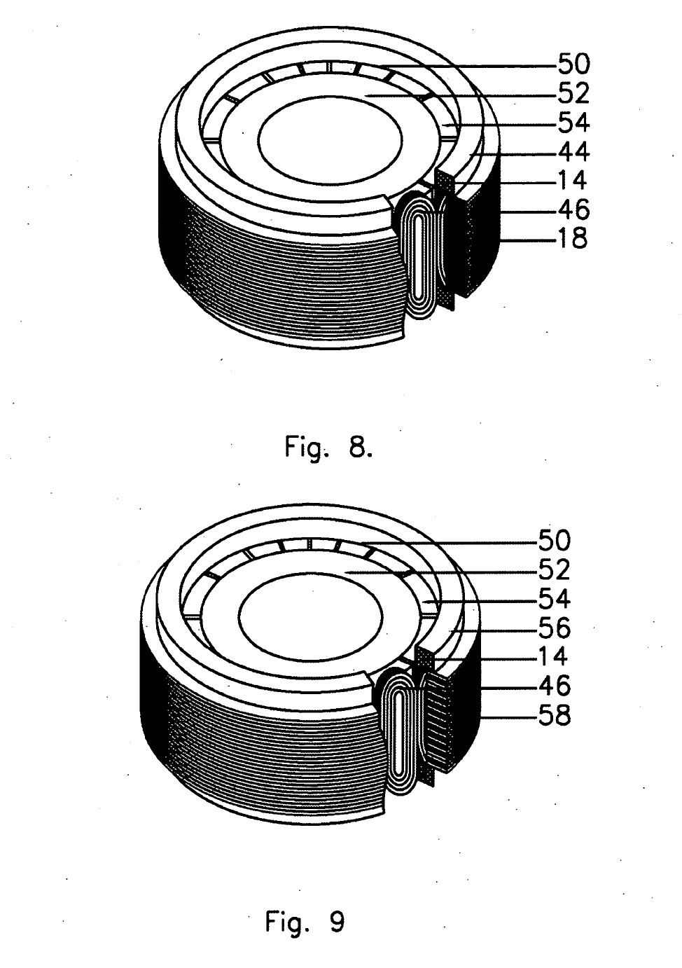

Rotary slotless electrical machine with stator that includes coils and ferromagnetic solid or laminated core for coils mounting is shown on FIG. 8. Stator 44 consists of coils 46 encapsulated in epoxy 14 and ferromagnetic core 48. Rotor 50 consists of bushing 52 and magnets 54.

The invented rotary slotless electrical machine construction includes stator 56 consisted of coils 46 encapsulated in epoxy 14, and mixed ferromagnetic/non-ferromagnetic core 58 (FIG. 9). The mixed core replaces conventional ferromagnetic core 48. In the invented electrical machine the attraction and cogging force is reduced.

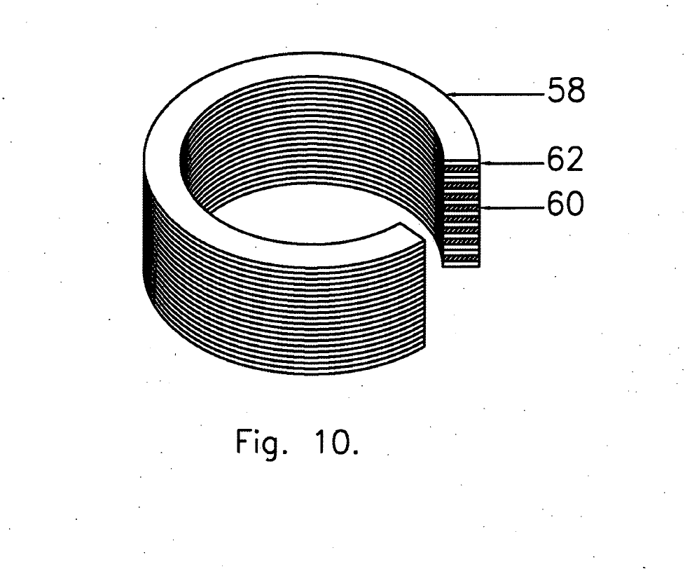

The mixed core 58 for rotary slotless electrical machine is shown on FIG. 10. It is made of ferromagnetic (oriented or non-oriented) laminations 60 and non-ferromagnetic laminations 62. Ferromagnetic and non-ferromagnetic laminations alternate along the core length.

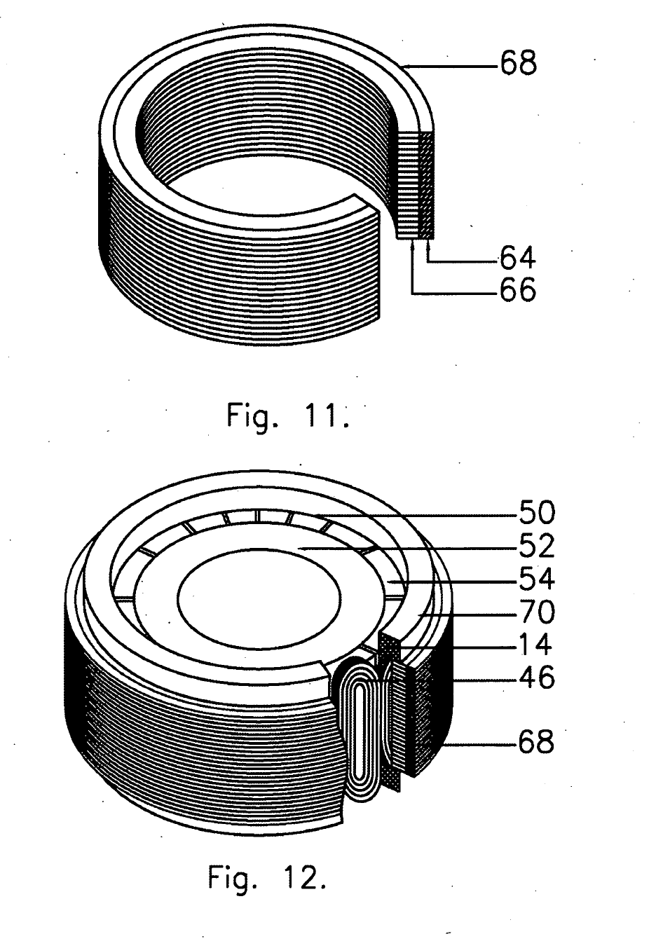

The mixed core can also be made of ferromagnetic laminations 64 and non-ferromagnetic laminations 66 that alternate along the core radius. The construction of radial mixed core 68 is shown on FIG. 11. The invented rotary slotless electrical machine construction that includes stator 70 with radial mixed core 68 is shown on FIG. 12.

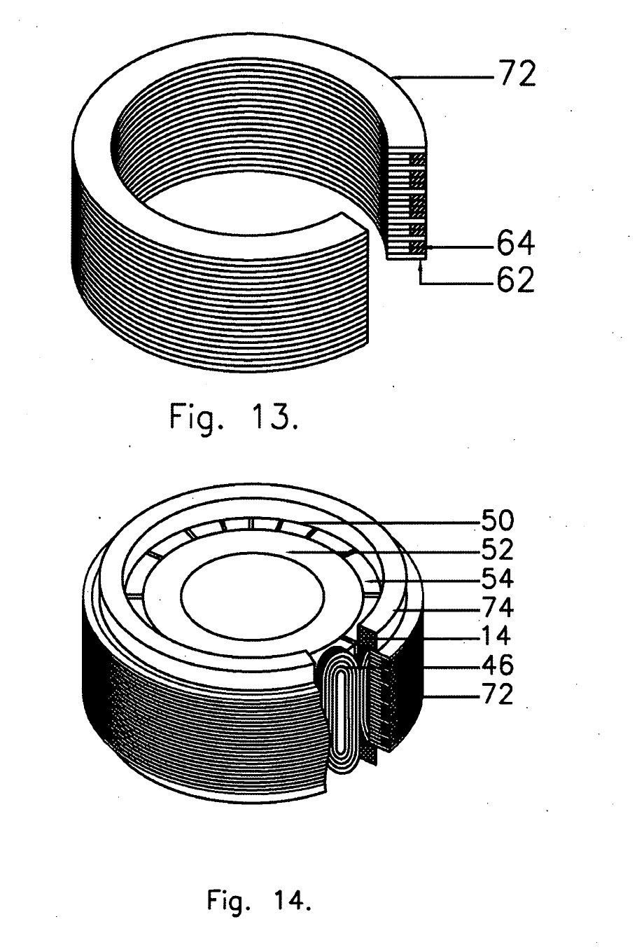

The mixed core can also be made of ferromagnetic laminations 64 and non-ferromagnetic laminations 62 and 66 that alternate both along the core length and along the core radius. The construction of random mixed core 72 is shown on FIG. 13. The invented rotary slotless electrical machine construction that includes stator 74 with random mixed core 72 is shown on FIG. 14.

The exact dimensions, mutual position and quantity of ferromagnetic laminations 60 and 64 and non-ferromagnetic laminations 62 and 66 for any type of mixed core depend on electromechanical design and are subject for optimization.

Linear Tube Slotless Electrical Machine (Internal Magnets) with Mixed Core.

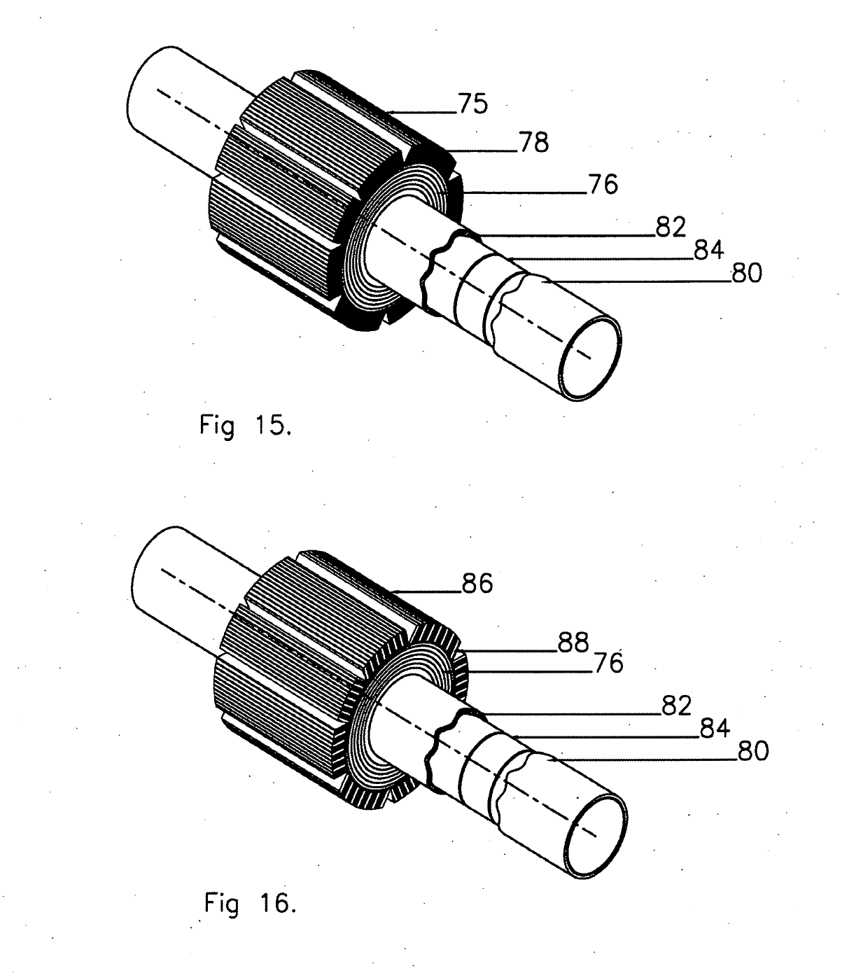

Linear tube slotless electrical machine (internal magnets) with forcer that includes coils and ferromagnetic solid or laminated core is shown on FIG. 15. Forcer 75 consists of coils 76 and ferromagnetic core 78. Magnet track 80 consists of tube 82 and magnets 84.

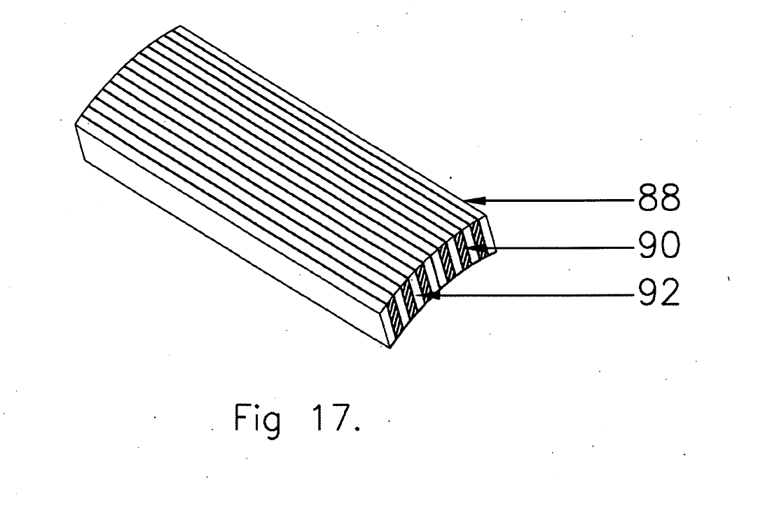

The invented linear tube slotless electrical machine (internal magnets) construction includes forcer 86 consisted of coils 76 and mixed ferromagnetic/non-ferromagnetic core 88 (FIG. 16). The mixed core replaces conventional ferromagnetic core 78. In the invented electrical machine the attraction and cogging force is reduced.

The mixed core 88 for linear tube slotless electrical machine (internal magnets) is shown on FIG. 17. It is made of ferromagnetic (oriented or non-oriented) laminations 90 and non-ferromagnetic laminations 92. Ferromagnetic and non-ferromagnetic laminations alternate along the core arc.

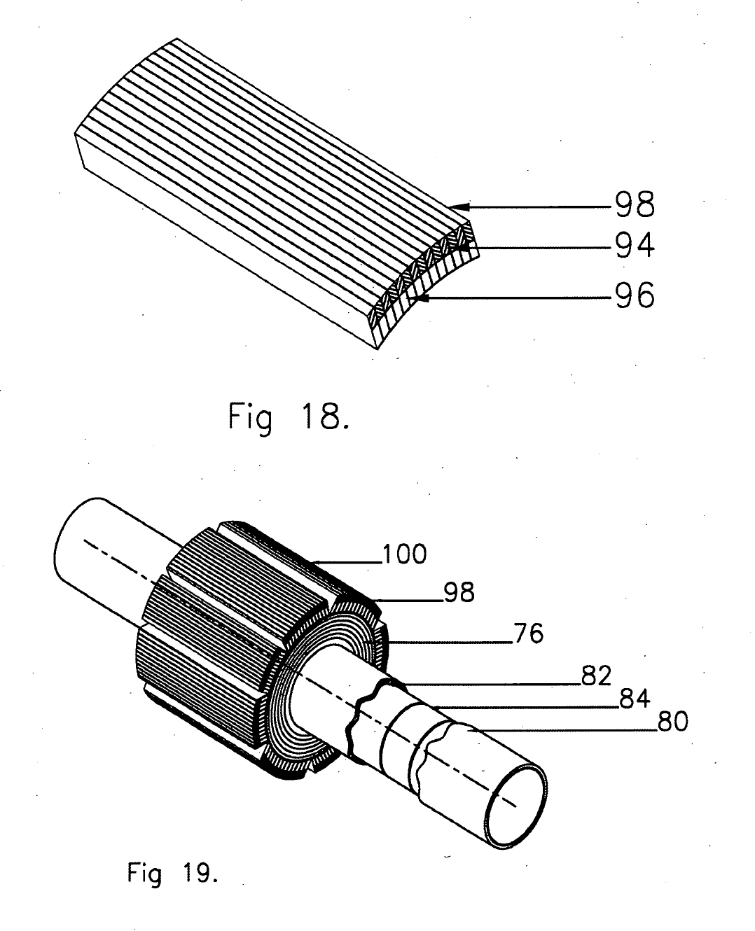

The mixed core can also be made of ferromagnetic laminations 94 and non-ferromagnetic laminations 96 that alternate along the core radius. The construction of radial mixed core 98 is shown on FIG. 18. The invented linear tube slotless electrical machine (internal magnets) construction that includes forcer 100 with radial mixed core 98 is shown on FIG. 19.

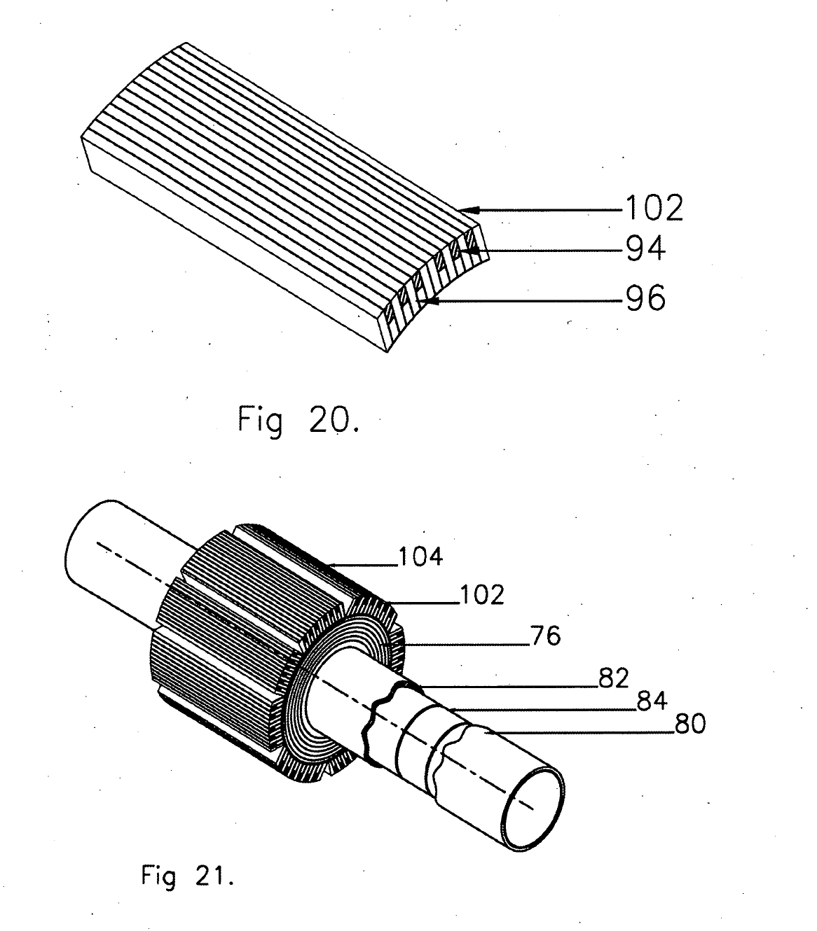

The mixed core can also be made of ferromagnetic laminations 94 and non-ferromagnetic laminations 92 and 96 that alternate both along the core arc and along the core radius. The construction of random mixed core 102 is shown on FIG. 20. The invented linear tube slotless electrical machine (internal magnets) construction that includes forcer 104 with random mixed core 102 is shown on FIG. 21.

The exact dimensions, mutual position and quantity of ferromagnetic laminations 90 and 94 and non-ferromagnetic laminations 92 and 96 for any type of mixed core depend on electromechanical design and are subject for optimization.

Linear Tube Slotless Electrical Machine (External Magnets) with Mixed Core.

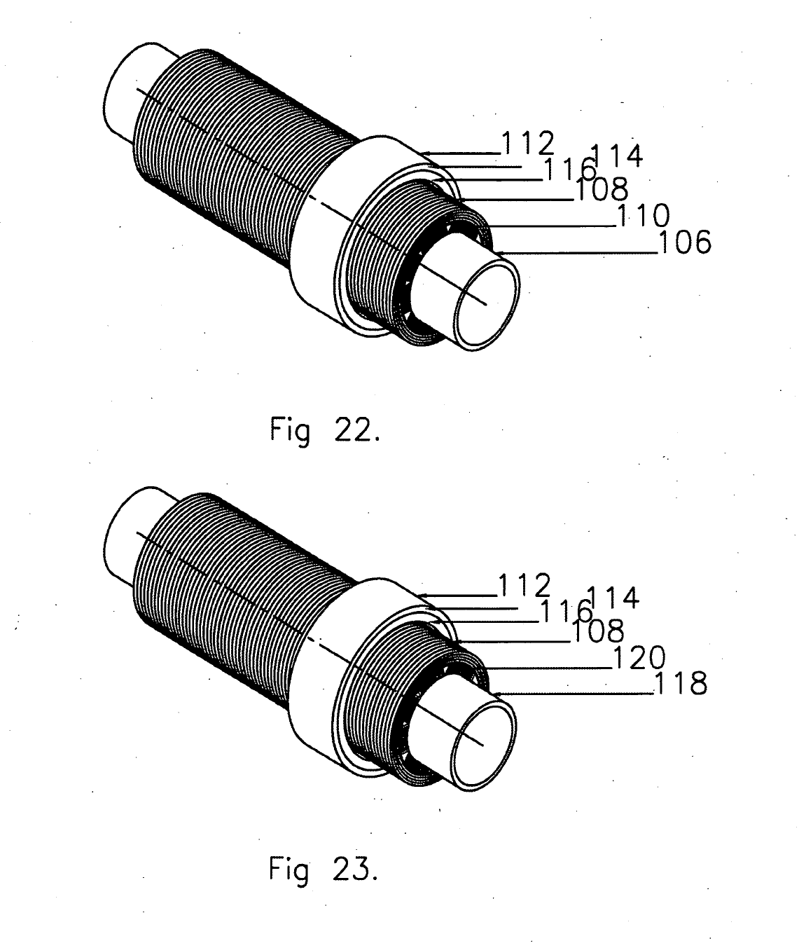

Linear tube slotless electrical machine (external magnets) with forcer that includes coils and ferromagnetic solid or laminated core is shown on FIG. 22. Forcer 106 includes coils 108 and ferromagnetic core 110. Magnet track 112 consists of tube 114 and magnets 116.

The invented linear tube slotless electrical machine (external magnets) construction includes forcer 118 consisted of coils 108 and mixed ferromagnetic/non-ferromagnetic core 120 (FIG. 23). The mixed core replaces conventional ferromagnetic core 110. In the invented electrical machine the attraction and cogging force is reduced.

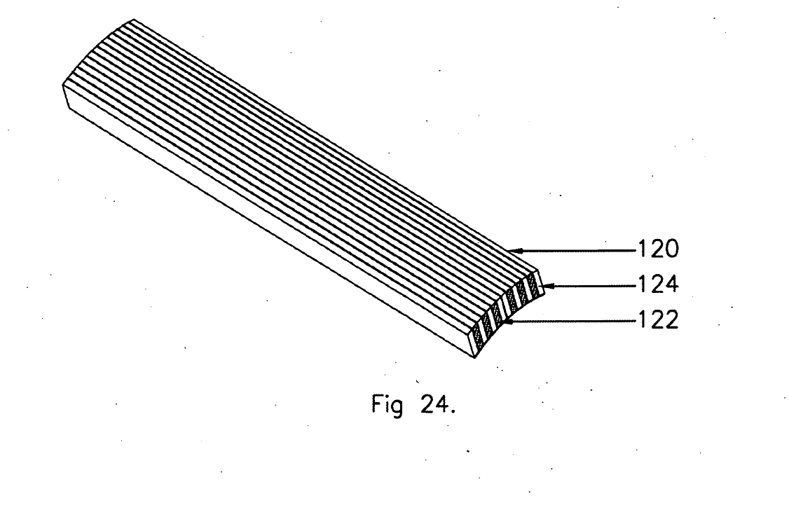

The mixed core 120 for linear tube slotless electrical machine (external magnets) is shown on FIG. 24. It is made of ferromagnetic (oriented or non-oriented) laminations 122 and non-ferromagnetic laminations 124. Ferromagnetic and non-ferromagnetic laminations alternate along the core arc.

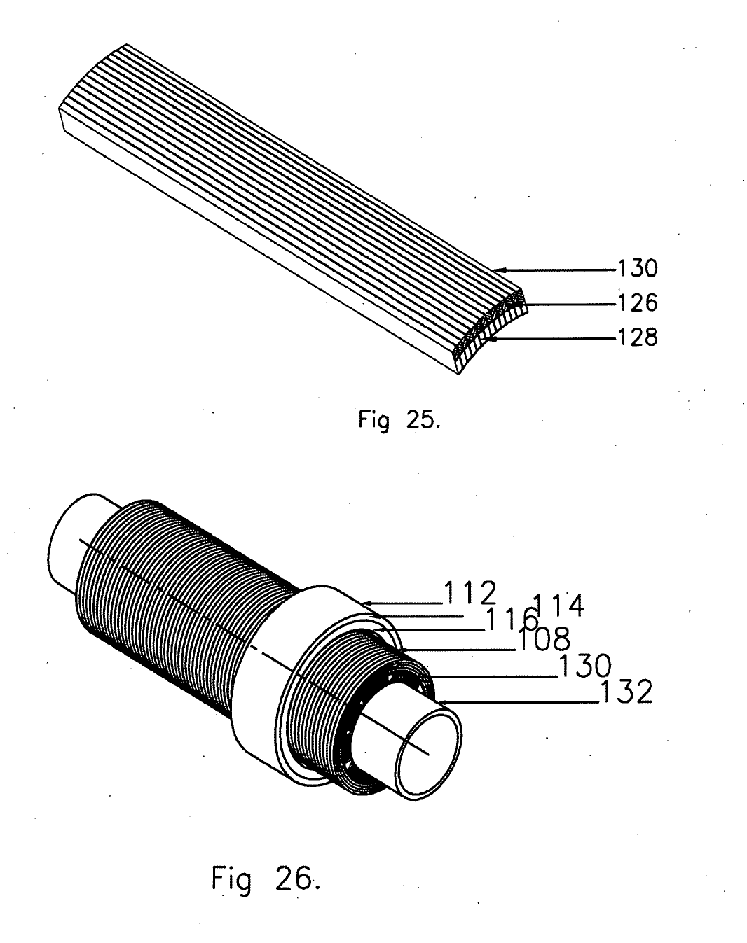

The mixed core can also be made of ferromagnetic laminations 126 and non-ferromagnetic laminations 128 that alternate along the core radius. The construction of radial mixed core 130 is shown on FIG. 25. The invented linear tube slotless electrical machine (external magnets) construction that includes forcer 132 with radial mixed core 130 is shown on FIG. 26.

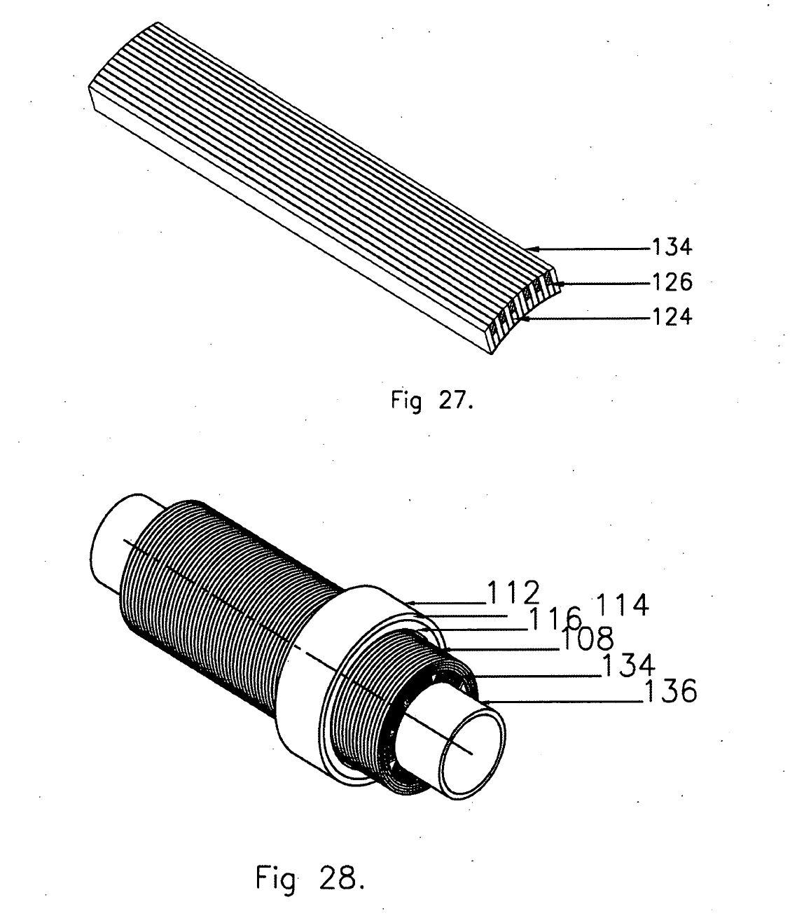

The mixed core can also be made of ferromagnetic laminations 126 and non-ferromagnetic laminations 124 and 128 that alternate both along the core arc and along the core radius. The construction of random mixed core 134 is shown on FIG. 27. The invented linear tube slotless electrical machine (external magnets) construction that includes forcer 136 with random mixed core 134 is shown on FIG. 28.

The exact dimensions, mutual position and quantity of ferromagnetic laminations 122 and 126 and non-ferromagnetic laminations 124 and 128 for any type of mixed core depend on electromechanical design and are subject for optimization.

1. A slotless electrical machine, comprising:
mixed ferromagnetic/non-ferromagnetic core, mixed core having both ferromagnetic and non-ferromagnetic laminations.

2. A linear flat slotless electrical machine, comprising:
mixed ferromagnetic/non-ferromagnetic core, mixed core having both ferromagnetic and non-ferromagnetic laminations, the ferromagnetic and non-ferromagnetic laminations alternate inside the mixed core alone the core width.

3. A linear flat slotless electrical machine, comprising:
mixed ferromagnetic/non-ferromagnetic core, mixed core having both ferromagnetic and non-ferromagnetic laminations, the ferromagnetic and non-ferromagnetic laminations alternate inside the mixed core along the core height.

4. A linear flat slotless electrical machine, comprising:
random mixed ferromagnetic/non-ferromagnetic core, random mixed core having both ferromagnetic and non-ferromagnetic laminations, the ferromagnetic and non-ferromagnetic laminations alternate inside the mixed core along the core width and height.

5. A rotary slotless electrical machine, comprising:
mixed ferromagnetic/non-ferromagnetic core, mixed core having both ferromagnetic and non-ferromagnetic laminations, the ferromagnetic and non-ferromagnetic laminations alternate inside the mixed core along the core length.

6. A rotary slotless electrical machine, comprising:
radial mixed ferromagnetic/non-ferromagnetic core, radial mixed core having both ferromagnetic and non-ferromagnetic laminations, the ferromagnetic and non-ferromagnetic laminations alternate inside the mixed core along the core radius.

7. A rotary slotless electrical machine, comprising:
random mixed ferromagnetic/non-ferromagnetic core, random mixed core having both ferromagnetic and non-ferromagnetic laminations, the ferromagnetic and non-ferromagnetic laminations alternate inside the mixed core along the core radius and length.

8. A linear tubular slotless (internal magnets) electrical machine, comprising:
mixed ferromagnetic/non-ferromagnetic core, mixed core having both ferromagnetic and non-ferromagnetic laminations, the ferromagnetic and non-ferromagnetic laminations alternate inside the mixed core along the core arc.

9. A linear tubular slotless (internal magnets) electrical machine, comprising:
radial mixed ferromagnetic/non-ferromagnetic core, radial mixed core having both ferromagnetic and non-ferromagnetic laminations, the ferromagnetic and non-ferromagnetic laminations alternate inside the mixed core along the core radius.

10. A linear tubular slotless (internal magnets) electrical machine, comprising:
random mixed ferromagnetic/non-ferromagnetic core, random mixed core having both ferromagnetic and non-ferromagnetic laminations, the ferromagnetic and non-ferromagnetic laminations alternate inside the mixed core along the core radius and arc.

11. A linear tubular slotless (external magnets) electrical machine, comprising:
mixed ferromagnetic/non-ferromagnetic core, mixed core having both ferromagnetic and non-ferromagnetic laminations, the ferromagnetic and non-ferromagnetic laminations alternate inside the mixed core along the core arc.

12. A linear tubular slotless (external magnets) electrical machine, comprising:
radial mixed ferromagnetic/non-ferromagnetic core, radial mixed core having both ferromagnetic and non-ferromagnetic laminations, the ferromagnetic and non-ferromagnetic laminations alternate inside the mixed core along the core radius.

13. A linear tubular slotless (external magnets) electrical machine, comprising:
random mixed ferromagnetic/non-ferromagnetic core, random mixed core having both ferromagnetic and non-ferromagnetic laminations, the ferromagnetic and non-ferromagnetic laminations alternate inside the mixed core along the core radius and arc.
